(19) United States
(12) Patent Application Publication
(10) Pub. No.: US 2025/0114921 A1
(43) Pub. Date: Apr. 10, 2025

(54) PIPE FITTING TOOL

(71) Applicant: MILWAUKEE ELECTRIC TOOL CORPORATION, Brookfield, WI (US)

(72) Inventors: Benjamin A. Smith, Milwaukee, WI (US); James Wekwert, Whitefish Bay, WI (US); Brandon L. Yahr, Slinger, WI (US)

(21) Appl. No.: 18/728,578

(22) PCT Filed: Jan. 13, 2023
(86) PCT No.: PCT/US2023/010791

§ 371 Date: Jul. 12, 2024

Related U.S. Application Data
(60) Provisional application No. 63/299,295, filed on Jan. 13, 2022.

(51) Int. Cl. B25B 21/00; B25B 23/00

(52) U.S. Cl. CPC B25B 21/002; B25B 23/0085

(57) ABSTRACT

A pipe fitting tool is configured to loosen a first pipe element with respect to a second pipe element. The pipe fitting tool includes a motor, a holdback assembly configured to clamp and hold the second pipe element, the holdback assembly including a fixed jaw, a movable jaw, and a plurality of teeth sections, and a drive assembly. The drive assembly is configured to clamp and rotate the first pipe element with respect to the second pipe element in response to a first linear motion of the reciprocating member, and release the first pipe element in response to a second linear motion of the reciprocating member, the second linear motion being in a direction opposite the first linear motion. At least one of the plurality of teeth sections is pivotally coupled to the fixed jaw.

### CROSS-REFERENCE TO RELATED APPLICATIONS

This application claims priority to U.S. Provisional Patent Application No. 63/299,295, filed Jan. 13, 2022, the entire content of which is incorporated herein by reference.

### BACKGROUND

The present disclosure relates to power tools, and more particularly to pipe fitting and plumbing tools. Pipe fitting tools are used to connect and disconnect pipes, which often use threaded joints to connect to each other.

### SUMMARY OF THE DISCLOSURE

The present disclosure provides, in one aspect a pipe fitting tool configured to loosen a first pipe element with respect to a second pipe element. The pipe fitting tool includes a motor, a holdback assembly configured to clamp and hold the second pipe element, the holdback assembly including a fixed jaw, a movable jaw, and a plurality of teeth sections, and a drive assembly. The drive assembly is configured to clamp and rotate the first pipe element with respect to the second pipe element in response to a first linear motion of the reciprocating member, and release the first pipe element in response to a second linear motion of the reciprocating member, the second linear motion being in a direction opposite the first linear motion. At least one of the plurality of teeth sections is pivotally coupled to the fixed jaw.

The present disclosure provides, in one aspect a pipe fitting tool configured to loosen a first pipe element with respect to a second pipe element. The pipe fitting tool includes a motor, a holdback assembly configured to clamp and hold the second pipe element, the holdback assembly including a fixed jaw, a movable jaw, and a plurality of teeth sections, and a drive assembly. The drive assembly is configured to clamp and rotate the first pipe element with respect to the second pipe element in response to a first linear motion of the reciprocating member, and release the first pipe element in response to a second linear motion of the reciprocating member, the second linear motion being in a direction opposite the first linear motion. The plurality of teeth sections includes a first teeth section having teeth angled in a first direction corresponding to a rotational direction of the second pipe element, and the plurality of teeth sections includes a second teeth section having teeth angled in a second direction opposing the rotational direction of the second pipe element.

The present disclosure provides, in another aspect, a pipe fitting tool configured to loosen a first pipe element with respect to a second pipe element. The pipe fitting tool includes a fixed jaw with first and second teeth sections and a movable jaw including third and fourth teeth sections. The first teeth section and the second teeth section have teeth angled in a first direction corresponding to a rotational direction of the second pipe element, and the third teeth section has teeth angled in a second direction opposing the rotational direction of the second pipe element.

Other features and aspects of the disclosure will become apparent by consideration of the following detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

FIG. 1A is a perspective view of a pipe fitting tool according to an embodiment of the present disclosure, with portions of a housing of the pipe fitting tool hidden.

FIG. 1B is another perspective view of the pipe fitting tool of FIG. 1A, with the portions of the housing shown.

FIG. 2 is a side view of a holdback assembly of the pipe fitting tool of FIG. 1A.

FIG. 3 is an enlarged view illustrating jaws of the holdback assembly of FIG. 2.

FIG. 4 is a side view of a portion of the holdback assembly of FIG. 2.

FIG. 5 is a perspective view of a drive assembly of the pipe fitting tool of FIG. 1.

FIG. 6 is a cross-sectional view of a portion of the drive assembly of FIG. 5.

FIG. 7 is an enlarged cross-sectional view of a portion of the drive assembly of FIG. 5.

FIG. 8 is a perspective view of a lever support and sled of the drive assembly of the pipe fitting tool of FIG. 1.

FIG. 9 is an enlarged perspective view of a portion of the drive assembly of FIG. 5, with portions removed for clarity.

FIG. 10 is a cross-sectional view of the portion of the drive assembly of FIG. 9.

FIG. 11 is an enlarged perspective view of a portion of the drive assembly of FIG. 5.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

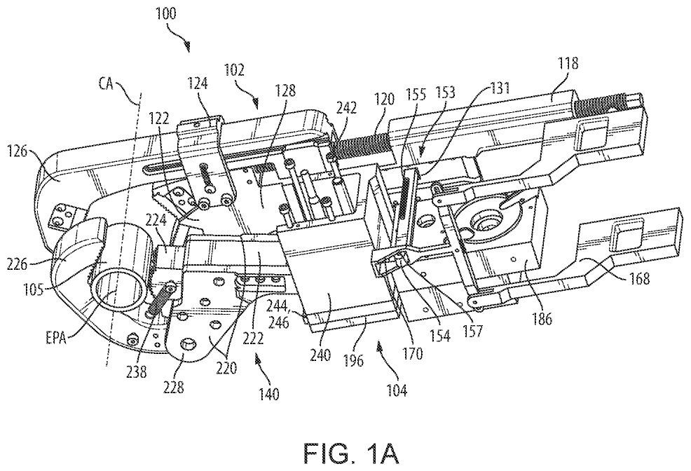

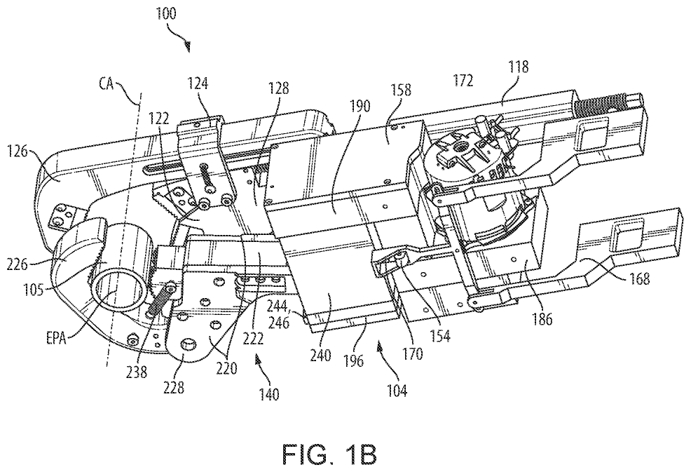

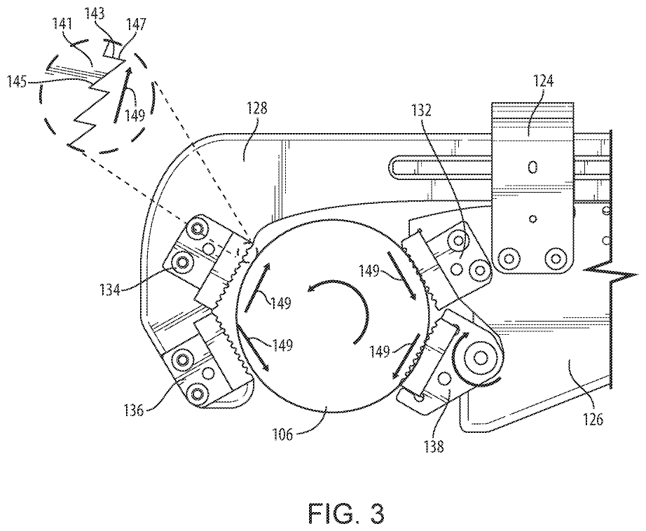

FIGS. 1A and 1B illustrate a pipe fitting tool 100 including a holdback assembly 102 configured to clamp and hold a second pipe element 106 (FIG. 3), and a drive assembly 104 configured to loosen a first pipe element 105 with respect to the second pipe element 106, as explained in further detail below. The first pipe element 105 and the second pipe element 106 may be sections of pipe or pipe fittings, such as couplings, valves, unions, or the like. The pipe fitting tool 100 includes a housing 158 and a motor 172 positioned adjacent the housing 158. (FIG. 1B). The motor 172 is supported by a platform 186 coupled to and/or extending from the housing 158. The holdback assembly 102 is a separate structure coupled to the drive assembly 104 such that the two can move in relation to one another.

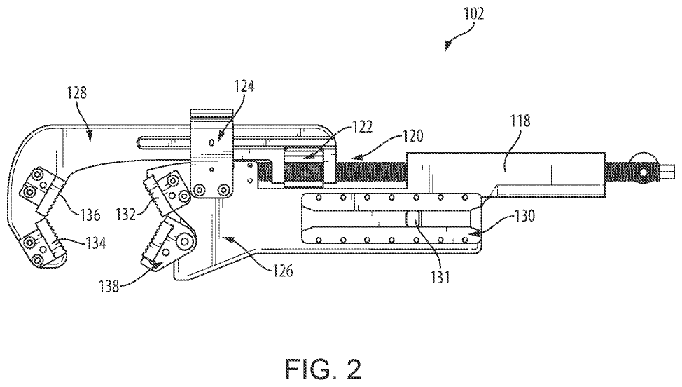

In the illustrated embodiment, the pipe fitting tool 100 includes a locking mechanism 153 with a crossbar 154 that selectively locks the drive assembly 104 to a frame 118 of the holdback assembly 102. The crossbar 154 extends transversely through the housing 158 of the pipe fitting tool 100, and an end of the crossbar 154 is insertable into an aperture 131 in the holdback assembly 102 to lock the drive assembly 104 to the holdback assembly 104. The illustrated locking mechanism 153 includes a spring 155, which biases the crossbar 154 into the aperture 131, and which automatically moves the end of the crossbar 154 into the aperture 131 (FIGS. 1A and 2) in the frame 118. In the illustrated embodiment, the crossbar 154 and the aperture 131 each have a rectangular (and more specifically, a square) cross-sectional shape; however the crossbar 154 and aperture 131 may have other corresponding shapes in other embodiments. In the illustrated embodiment, the aperture 131 is a through-hole extending through the frame 118; however, the aperture 131 may alternatively be a recess that does not extend entirely through the frame 118.

Referring to FIG. 1A, in some embodiments, a pin 157 extends through the crossbar 154 proximate a second end of the crossbar 154 (i.e. opposite the end of the crossbar 154 that engages the aperture 131). The illustrated locking mechanism 153 includes an actuator or linkage 168, which may be moved (e.g., in a direction away from a jaw assembly 140 of the drive assembly 104) along the housing 158 to withdraw the crossbar 154 from the aperture 131. In more detail, the linkage 168 has ramps 170, which engage the pin 157 as the linkage 168 is moved along the housing 158. This causes the crossbar 154 to move against the biasing force of the spring 155 and in an orthogonal direction away from the aperture 131, until the end of the crossbar 154 clears the aperture 131. The locking mechanism 153 is then unlocked, and, the position of the drive assembly 104 may then be adjusted with respect to the holdback assembly 102. When the crossbar 154 is moved back into alignment with the aperture 131, the spring 155 automatically moves the crossbar 154 back into engagement with the aperture 131.

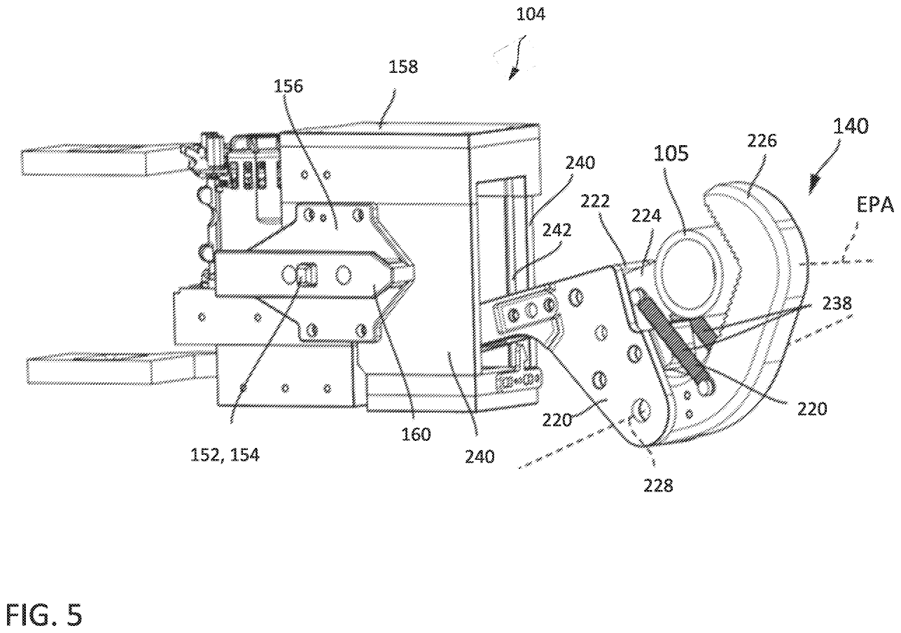

FIG. 2 illustrates the holdback assembly 102 separate from the drive assembly 104. The illustrated holdback assembly 102 includes a leadscrew 120 supported by the frame 118, a nut 122 in threaded engagement with the leadscrew 120, and a top hoop 124 fixed to the frame 118. The holdback assembly 102 further includes a fixed jaw 126, a moveable jaw 128, and a t-slot 130. As illustrated in FIG. 5, a bracket 156 coupled to the housing 158 of the drive assembly 104 includes a sliding potion 160 configured to be received in the t-slot 130. The t-slot 130 may thus guide movement of the holdback assembly 102 relative to the drive assembly 104 (e.g., when the locking mechanism 153 is unlocked.)

With continued reference to FIG. 2, the nut 122 is fixed to the moveable jaw 128, such that rotation of the leadscrew 120 relative to the nut 122 causes the moveable jaw 128 to advance or retract (i.e. move further from or closer to) relative to the fixed jaw 126. The leadscrew 120 may be driven by the motor 172 in some embodiments, or the leadscrew 120 may alternatively be driven by a second motor (not shown) or via manual rotation by a user. The top hoop 124 guides and maintains substantially linear longitudinal movement of the moveable jaw 128 relative to the fixed jaw 126.

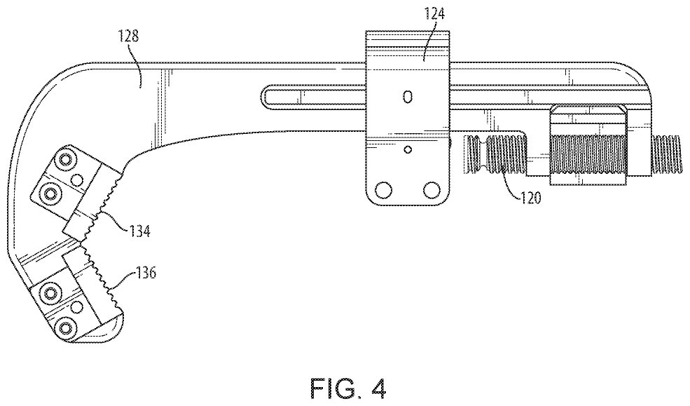

Referring to FIG. 4, in some embodiments, a pair of spring-biased bearings or rollers are disposed within the top hoop 124. The rollers may extend between the frame 118 of the holdback assembly 102 and the moveable jaw 128 to bias a portion of the moveable jaw 128 forward of the leadscrew 120 in a direction away from the frame 118 (FIGS. 2 and 4). The moveable jaw 128 is slidable along the rollers, which reduce friction and prevent marring of the moveable jaw 128 and/or the frame 118. This in turn provides for smoother adjustment of the moveable jaw 128 relative to the fixed jaw 126.

The holdback assembly 102 is a capable of gripping and holding a pipe or pipe fitting (e.g., the second pipe element 106; FIG. 3) between the fixed jaw 126 and the moveable jaw 128. To secure the jaws 126, 128 around a pipe, the moveable jaw 128 of the holdback assembly 102 is moveable with respect to the frame 118 via rotation of the screw 120, allowing the holdback assembly 102 to clamp and secure sections of pipes having different diameters. When the jaws 126, 128 are clamped on the second pipe element, through advancement of the moveable jaw 128, a central axis CA (FIGS. 1A-1B) of the second pipe element 106 is positioned between the jaws 126, 128, and the central axis CA of the second pipe element 106 is aligned with an effective pivot axis (EPA) of the jaw assembly 140 of the drive assembly 104.

With reference to FIG. 3, the illustrated holdback assembly 102 includes a plurality of teeth sections 132, 134, 136, 138 configured for gripping a substantially cylindrical pipe. Specifically, the moveable jaw 128 includes second and third teeth sections 134 and 136, and the fixed jaw 126 includes first and fourth teeth sections 132 and 138. Each of the teeth sections 132-138 includes a plurality of individual teeth 141, each having a leading edge 143, a trailing edge 145, and a peak 147 where the leading edge 143 intersects the trailing edge 143. The leading edge 143 and/or the trailing edge 145 may be linear or curved. The leading edge 143 in the illustrated embodiment is shorter and steeper than the trailing edge 145, such that the teeth 141 are angled in a teeth orientation direction 149.

With continued reference to FIG. 3, in the illustrated embodiment, the first, second, and fourth teeth sections 132, 134, 138 each have a teeth orientation direction 149 that opposes a torque applied to the second pipe element 106 during operation of the drive assembly 104 on the first pipe element 105. The peaks 147 of the teeth on these sections 132, 134, 138 therefore tend to dig into the second pipe element 106 to resist rotation of the second pipe element 106 and improve grip on the second pipe element 106.

In the illustrated embodiment, the third teeth section 136, however, is oriented in the opposite direction. That is, the third teeth section 136 has a teeth orientation direction 149 in the same direction as the torque applied to the second pipe element 106. This orientation has been found to improve grip on the second pipe element 105 against forces in the opposite direction (e.g., which may occur between strokes of the drive assembly 104, when the drive assembly is repositioning itself in preparation for a subsequent stroke of the drive assembly 104). Thus, by providing three jaw sections 132, 134, 138 with a first teeth orientation direction 149 and a fourth jaw section 136 with a second, opposite teeth orientation direction 149, the holdback assembly 102 advantageously maintains a secure hold on the second pipe element 105 in all stages of operation of the tool 100.

Referring to FIG. 3, in the illustrated embodiment, the fourth teeth section 138 is pivotally coupled to the fixed jaw 126. As such, when torque is applied to the second pipe element 106 in the direction shown in FIG. 3, the tangential force on the fourth teeth section 138 causes the fourth teeth section 138 to pivot as shown in FIG. 3. This pivoting presses the fourth teeth section 138 on to the outer surface of the second pipe element 106 and in turn increases the grip on the pipe element 106. Thus, the pivotable teeth section 138 provides a grip amplification by naturally rotating opposite direction of the overall rotation or torque direction on the second pipe element 106.

FIG. 4 illustrates moveable jaw 128 with the leadscrew 120. The illustrated leadscrew 120 provides at least 600 pounds of compression preload on the second pipe element 106 when 50 inch-pounds of torque is applied to the leadscrew 120. With 600 pounds of preload compression on the second pipe element 106, the holdback assembly 102 can resist at least 1,800 foot pounds of torque exerted by the drive assembly 104 without slipping.

The drive assembly 104 will now be described with reference to FIGS. 5-11. It should be understood, however, that the pipe fitting tool 100 may be configured to include any of the drive assemblies described in U.S. patent application Ser. No. 17/374,508, filed Jul. 13, 2021 in the name of Milwaukee Electric Tool Corporation, the entire content of which is incorporated herein by reference.

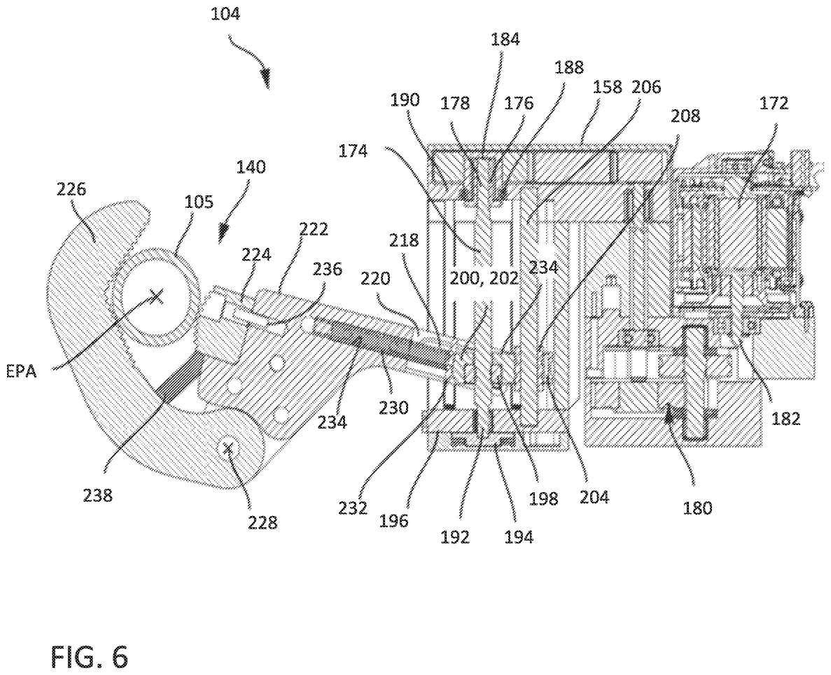

With reference to FIG. 6, the illustrated drive assembly 104 includes the electric motor 172, a leadscrew 174, and gear train 180 to transfer torque from the motor 172 to the leadscrew 174. The electric motor 172 is preferably powered by a battery removably coupled to the housing 158. In the illustrated embodiment, an output shaft 182 of the motor extends parallel to the leadscrew 174. Specifically, a first end 178 of the leadscrew 174 is arranged in and coupled for rotation with a drive member 176. The drive member 176 is configured to rotate with a torque transfer member 184 coupled for rotation with a gear of the gear train 180, via a Double-D cross-sectional geometry, but is configured to move axially with respect to the torque transfer member 184. A thrust bearing 188 is arranged around the torque transfer member 184 and is set in an upper portion 190 of the housing 158. Because the drive member 176 is configured to move axially with respect to the torque transfer member 184, the axial thrust force received by the gear is reduced, thus preventing the gear from binding. A second end 192 of the leadscrew 174 is arranged in a thrust bearing 194 in a lower portion 196 of the housing 158. In some embodiments, the thrust bearing 194 is configured to absorb up to 3,000 pound of thrust load exerted by the leadscrew 174 on the thrust bearing 194 during a pipe loosening operation.

With continued reference to FIG. 6, a nut 198 is threadably arranged for movement along the leadscrew 174. The nut 198 is captured within a first end 200 of a carriage 202 that also has a second end 204 arranged around and configured to move along a post 206 in the housing 158, via a sleeve 208 (e.g., a low-friction sleeve, linear bearing, or the like). Because the carriage 202 is arranged on the leadscrew 174 (via the nut 198) and the post 206 (via the sleeve 208), the carriage 202 is inhibited from rotating within the housing 158 and is only capable of moving between the upper and lower portions 190, 196 of the housing 158. Because the nut 198 is captured within the carriage 202, the nut 198 is inhibited from rotating about the leadscrew 174. Thus, in response to rotation of the leadscrew 174, the nut 198 will move along the leadscrew 174 between the upper and lower portions 190, 196 of the housing 158, causing the carriage 202 to move therewith.

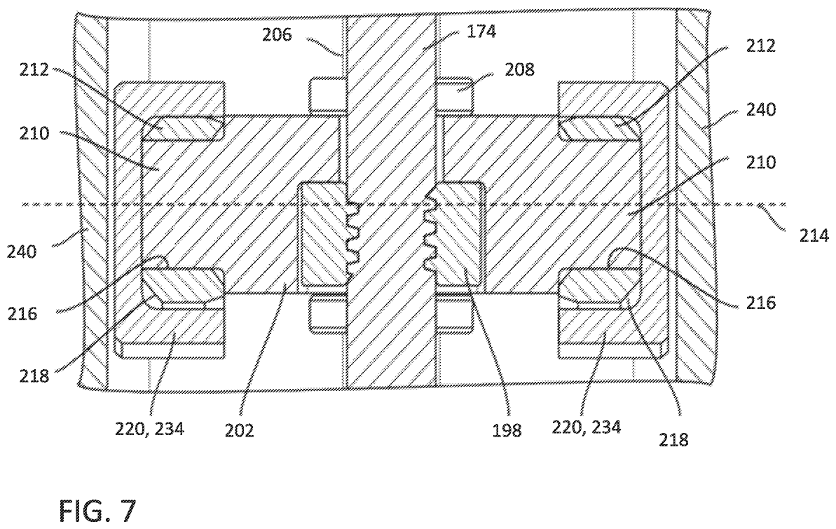

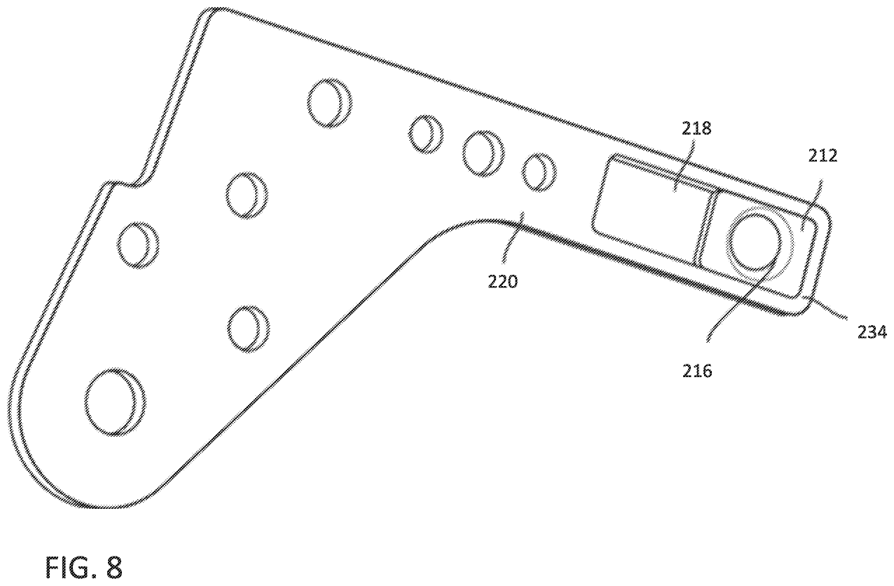

As shown in FIG. 7, the carriage 202 has two hubs 210 on which a pair of sleds 212 are respectively arranged. The hubs 210 define a hub axis 214, which extends centrally through the hubs 210, and each of the sleds 212 has a recess 216 (FIG. 8) to accommodate a respective one of the hubs 210. Each of the sleds 212 is respectively arranged in a slot 218 of one of a pair of lever supports 220, such that the sleds 212 may move along the slots 218 during a pipe loosening operation, as discussed in further detail below. The jaw assembly 140 of the drive assembly 104 includes the lever supports 220, a lever arm 222 coupled between the lever supports 220, a first jaw 224 coupled to the lever arm 222, and a second jaw 226 pivotally coupled to each of the lever supports 220 along a common pivot axis 228 (FIGS. 5 and 6).

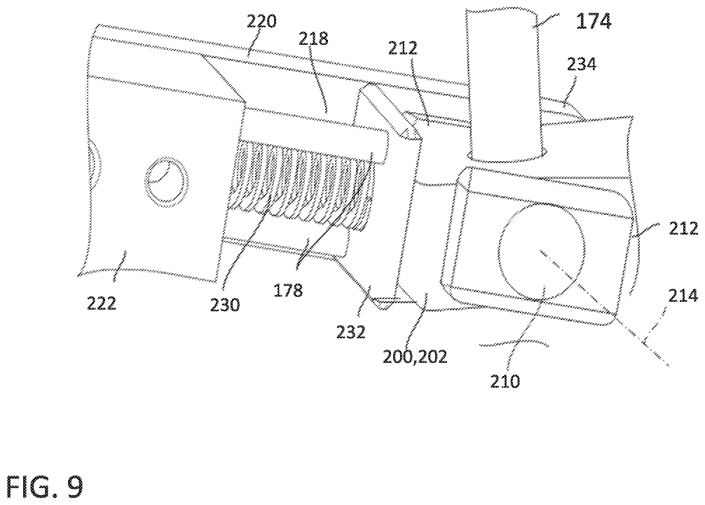

As shown in FIGS. 6 and 9, a spring 230 is seated against a spring slider 232 and arranged within a bore 234 of the lever arm 222. The spring slider 232 thus is biased by the spring 230 against the carriage 202. The lever arm 222 and both lever supports 220 are thus biased by the spring 230 away from the spring slider 232 and toward the first pipe element 105, such that in a neutral position the sleds 212 are arranged in the slots 218 toward ends 234 of the lever supports 220 (FIG. 9).

A pair of pins 594 extend from the spring slider 232 and into the lever arm 222 to inhibit the spring slider 232 from rotating with respect to the lever arm 222 (FIG. 9). As shown in FIG. 6, the first jaw 224 is removably coupled to the lever arm 222 via, for example, a fastener 236, such that different types of jaw pieces or replacement jaw pieces may replace the first jaw 224 on the lever arm 222.

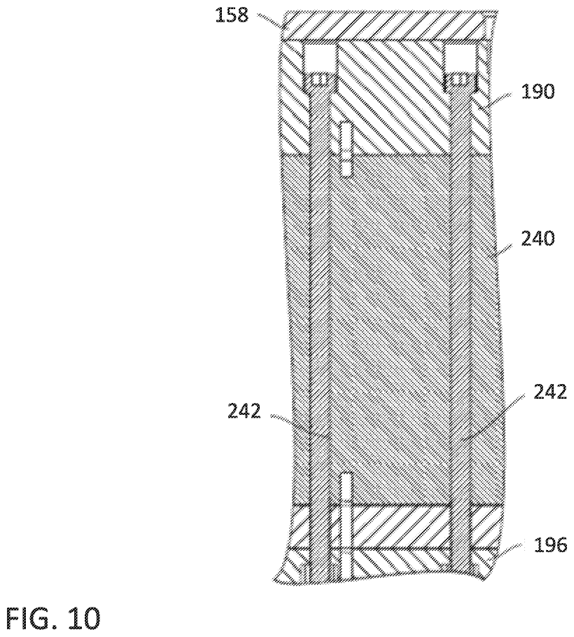

The second jaw 226 is biased toward the first jaw 224 via a pair of tension springs 238 coupled between the first and second jaws 224, 226. As shown in FIG. 10, a side portion 240 extends between the upper and lower portions 190, 196 of the housing 158 on opposite sides of the carriage 202. A pair of steel bolts 242 respectively extend through each of the side portions 240, coupling the upper and lower portions 190, 196 of the housing 158.

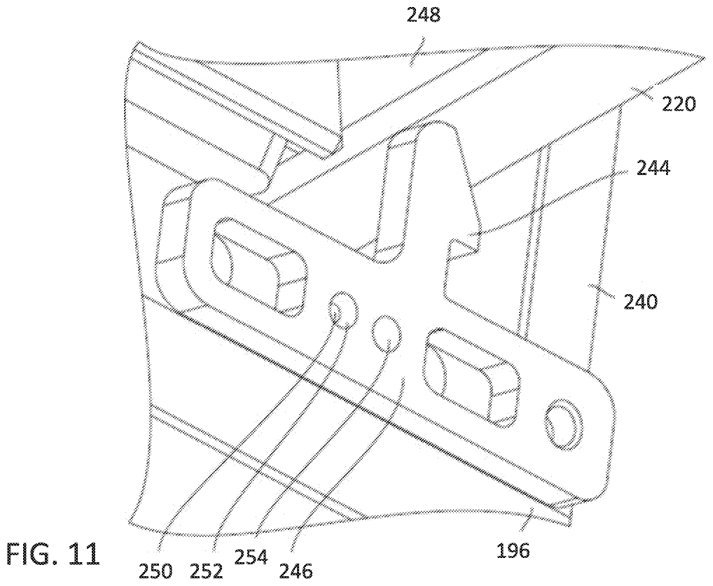

As shown in FIG. 11, a storage hook 244 on a slide member 246 is configured to hook onto a ledge 248 of one of the lever supports 220, thus hooking the jaw assembly 140 in a fixed storage position with respect to the housing 158, when the slide member 246 is locked in a first position via a detent 250 being biased into a first recess 252. The detent 250 can be depressed and the slide member 246 is slidable along the housing 158 to an unlocked position, in which the detent 250 is biased into a second recess 254, and the storage hook 244 releases the ledge 248, allowing the jaw assembly 140 to swing back to an operating position. By putting the jaw assembly 140 in a storage position during transport of the pipe fitting tool 100, damage to the jaw assembly 140 during transport can be prevented, as opposed to allowing the jaw assembly 140 to swing freely with respect to the housing 158.

In operation, after the drive assembly 104 has been set in the correct parallel position with respect to the holdback assembly 102 for a size of a particular pipe to be loosened, as described above, the jaws 224, 226 of the jaw assembly 140 are positioned on the first pipe element 105 while the jaws 126, 128 of the holdback assembly 102 are positioned on opposite sides of the second section pipe 106. The screw 120 of the holdback assembly 102 is then rotated in a tightening direction, thus moving the moveable jaw 128 toward the fixed jaw 126 to tighten around the second pipe element 106.

The motor 172 of the drive assembly 104 is then activated in a loosening direction, causing the leadscrew 174 to rotate in a loosening direction. Rotation of the leadscrew 174 in the loosening direction causes the carriage 202 to move toward the upper portion 190 of the housing 158, causing the ends 234 of the lever supports 220 to also move with the carriage 202. As the ends 234 of the lever supports 220 move with the carriage 202 toward the upper portion 190, the jaws 224, 226 of the drive assembly 104 rotate in a loosening direction about the effective pivot axis EPA (i.e. counterclockwise as viewed in FIGS. 1 and 6), which is coaxial with the central axis CA defined by the second pipe element 106, while clamping on the first pipe element 105, thus loosening the first pipe element 105 with respect to the second pipe element 106 that is being held by the jaws 126, 128 of the holdback assembly 102. As the first pipe element 105 is being loosened, the grip of the jaws 126, 128 on the second pipe element 106 is amplified because the pivotable teeth section 138.

After the motor 172 has rotated a predetermined amount in the loosening direction, the motor 172 reverses direction and rotates in an opposite, return direction, causing the leadscrew 174 to rotate in an opposite, return direction. Rotation of the leadscrew 174 in the return direction causes the carriage 202 to move toward the lower portion 196 of the housing 158, causing the ends 234 of the lever supports 220 to also move with the carriage 202. As the ends 234 of the lever supports 220 move with the carriage 202 toward the lower portion 196, the first and second jaws 224, 226 of the drive assembly 104 rotate in a return direction (i.e. clockwise as viewed in FIGS. 1 and 6) about the first pipe element 105. However, while rotating in the return direction, the second jaw 226 is permitted to pivot away from the first jaw 224, such that the first and second jaws 224, 226 do not clamp on the first pipe element 105 while rotating in the return direction, such that the first pipe element 105 is not “re-tightened” during a return movement. As the first and second jaws 224, 226 rotate in the return direction, the sleds 212 simultaneously rotate about the hubs 210 and move along the slots 218.

After the motor 172 has rotated a predetermined amount in the return direction, the motor 172 thereafter repeatedly executes “loosening” and “return” rotation cycles until the first pipe element 105 has become loosened with respect to the second pipe element 106. The loosening operation is complete, the operator rotates the leadscrew 120 in a loosening direction to unclamp the first and second jaws 126, 128 of the holdback assembly 102 from the second pipe element 106.

Thus, the present disclosure provides, among other things, a motorized pipe fitting tool with a holdback assembly having improved grip to reduce slipping in both rotational directions. The features of the jaws 126, 128 of the holdback assembly 102 described herein may also be incorporated into the drive assembly 104, as well as into drive assemblies of pipe fitting tools according to other embodiments, which may not include a holdback assembly. Various features and aspects of the disclosure are set forth in the following claims.

What is claimed is:

1. A pipe fitting tool configured to loosen a first pipe element with respect to a second pipe element, the pipe fitting tool comprising:
a motor;
a holdback assembly configured to clamp and hold the second pipe element, the holdback assembly including a fixed jaw, a movable jaw, and a plurality of teeth sections; and
a drive assembly configured to
clamp and rotate the first pipe element with respect to the second pipe element in response to a first linear motion of the reciprocating member, and
release the first pipe element in response to a second linear motion of the reciprocating member, the second linear motion being in a direction opposite the first linear motion,
wherein at least one of the plurality of teeth sections is pivotally coupled to the fixed jaw.

2. The pipe fitting tool of claim 1, further comprising a housing containing the motor and a battery removably coupled to the housing, wherein the battery is configured to provide power to the motor.

3. The pipe fitting tool of claim 1, wherein the holdback assembly includes a four teeth sections and wherein the drive assembly includes a second pair of jaws.

4. The pipe fitting tool of claim 1, wherein the plurality of teeth sections includes a first teeth section having teeth angled in a first direction corresponding to a rotational direction of the second pipe element, and wherein the plurality of teeth sections includes a second teeth section having teeth angled in a second direction opposing the rotational direction of the second pipe element.

5. The pipe fitting tool of claim 1, wherein the holdback assembly is adjustably positioned relative to the drive assembly.

6. The pipe fitting tool of claim 1, wherein the drive assembly includes a screw rotatably driven by the motor to clamp and rotate the first pipe element.

7. The pipe fitting tool of claim 1, wherein the holdback assembly includes a screw, and wherein a spacing between the fixed jaw and the moveable jaw is decreased in response to movement of the screw to clamp and hold the second pipe element.

8. The pipe fitting tool of claim 7, wherein the screw is configured such that applying 50 inch-pounds of torque on the screw imparts at least 600 pounds of clamping force on the second pipe element.

9. A pipe fitting tool configured to loosen a first pipe element with respect to a second pipe element, the pipe fitting tool comprising:
a motor;
a holdback assembly configured to clamp and hold the second pipe element, the holdback assembly including a fixed jaw, a movable jaw, and a plurality of teeth sections; and
a drive assembly configured to
clamp and rotate the first pipe element with respect to the second pipe element in response to a first linear motion of the reciprocating member, and
release the first pipe element in response to a second linear motion of the reciprocating member, the second linear motion being in a direction opposite the first linear motion,
wherein the plurality of teeth sections includes a first teeth section having teeth angled in a first direction corresponding to a rotational direction of the second pipe element, and
wherein the plurality of teeth sections includes a second teeth section having teeth angled in a second direction opposing the rotational direction of the second pipe element.

10. The pipe fitting tool of claim 9, wherein the first teeth section is fixed to the movable jaw.

11. The pipe fitting tool of claim 10, wherein the second teeth section is coupled to the fixed jaw.

12. The pipe fitting tool of claim 11, wherein the second teeth section is pivotally coupled to the fixed jaw.

13. The pipe fitting tool of claim 11, wherein the plurality of teeth sections further includes a third teeth section coupled to the fixed jaw and a fourth teeth section coupled to the movable jaw.

14. The pipe fitting tool of claim 13, wherein the third teeth section and the fourth teeth section each have teeth angled in directions opposing the rotational direction of the second pipe element.

15. The pipe fitting tool of claim 9, wherein the drive assembly includes a screw rotatably driven by the motor to clamp and rotate the first pipe element.

16. The pipe fitting tool of claim 9, wherein the holdback assembly includes a screw, and wherein a spacing between the fixed jaw and the moveable jaw is decreased in response to movement of the screw to clamp and hold the second pipe element.

17. The pipe fitting tool of claim 16, wherein the screw is configured such that applying 50 inch-pounds of torque on the screw imparts at least 600 pounds of clamping force on the second pipe element.

18. The pipe fitting tool of claim 9, further comprising a housing containing the motor and a battery removably coupled to the housing, wherein the battery is configured to provide power to the motor.

19. A pipe fitting tool configured to loosen a first pipe element with respect to a second pipe element, the pipe fitting tool comprising:
a fixed jaw including first and second teeth sections; and
a movable jaw including third and fourth teeth sections,
wherein the first teeth section and the second teeth section have teeth angled in a first direction corresponding to a rotational direction of the second pipe element, and
wherein the third teeth section has teeth angled in a second direction opposing the rotational direction of the second pipe element.

20. The pipe fitting tool of claim 19, wherein one of the first teeth section and the second teeth section is pivotally coupled to the fixed jaw.
